(19) United States
(12) Patent Application Publication
(10) Pub. No.: US 2017/0228399 A1
(43) Pub. Date: Aug. 10, 2017

(54) METHOD OF SEARCHING FOR MULTIMEDIA IMAGE

(71) Applicant: National Taipei University of Technology, Taipei City (TW)

(72) Inventors: Shaw Hwa HWANG, Taipei City (TW); Bing Chih YAO, Taipei City (TW); Kuan Lin CHEN, Taipei City (TW); Yao Hsing CHUNG, Taipei City (TW); Chi Jung HUANG, Taipei City (TW); Cheng Yu YEH, Taipei City (TW); Shun Chieh CHANG, Taipei City (TW); Li Te SHEN, Taipei City (TW); Chao Ping CHU, Taipei City (TW); Ning Yun KU, Taipei City (TW); Tzu Hung LIN, Taipei City (TW); Ming Che YEH, Taipei City (TW)

(21) Appl. No.: 15/016,779

(22) Filed: Feb. 5, 2016

(51) Int. Cl. G06F 17/30; G10L 25/51; G10L 17/24

(52) U.S. Cl. CPC G06F 17/30268; G06F 17/30274; G10L 17/24; G10L 25/51

(57) ABSTRACT

The present invention provides a method of searching for multimedia image. When a camera and a microphone are used for recording an image file, a software of speech recognition is used for converting the speech recorded by the microphone into a text file, and then the image file and the text file are combined to form a folder for storing into a data base. If a user wants to search for a certain image file, the data base is entered to search all folders, and a key word is used for searching the related text files so that the related image files are very easy to find.

### FIELD OF THE INVENTION

The present invention relates to a method of searching for multimedia image, and more particularly to a method of searching for multimedia image by setting up a text file for each multimedia image.

### BACKGROUND OF THE INVENTION

It is a modern life to use a camera or a smart phone for recording an image for storing into a PC or a cloud server and for searching/observation/research in the future. As the stored images become more and more, the user is very difficult to search the required images.

Referring to FIG. 1, a user 1 uses a camera 2 and a microphone 3 for recording an image file 4 and then to be stored into a data base 5. The data base 5 is in a PC or a cloud server. When the user 1 wants to review the image file 4, a search engine 6 (such as Google, Fast/AllTheWeb, AltaVista, Inktonmi, Teoma, WiseNut) is used for searching the data base 5. If the quantity of the image files 4 is not much, the required image file 4 can be selected by viewing one by one. But if the quantity of the image files 4 is very much, no one can search the required image file 4.

### SUMMARY OF THE INVENTION

The object of the present invention is to provide a method of searching for multimedia image. When a camera and a microphone are used for recording an image file, a software of speech recognition is used for converting the speech recorded by the microphone into a text file, and then the image file and the text file are combined to form a folder for storing into a data base. If a user wants to search for a certain image file, the data base is entered to search all folders, and a key word is used for searching the related text files so that the related image files are very easy to find.

The method of searching for multimedia image according to the present invention, comprising steps as below:

a. a user uses a camera and a microphone for recording an image file, a software of speech recognition is used for converting a speech recorded by the microphone into a text file, and then the image file and the text file are combined to form a folder to be stored in a data base;

b. if the user wants to search for a certain image file from the data base, a search engine is entered for inputting a key word;

c. enter into the data base to inquire if all folders are checked;

d. if the folders are not all checked, then enter a folder to check the related text file, compare with the key word to see if it is matched with the key word, if yes, then the related image file is taken out for displaying to the user, return to step c for checking other folders; if no match, then leave the folder, return to step c for checking other folders;

e. in step c, if all folders are checked, then stop searching.

### BRIEF DESCRIPTION OF THE DRAWINGS

FIG. 1 shows schematically a conventional way by using a camera and a microphone for recording an image file to be stored into a data base, and then using a search engine for searching the required image file in the data base.

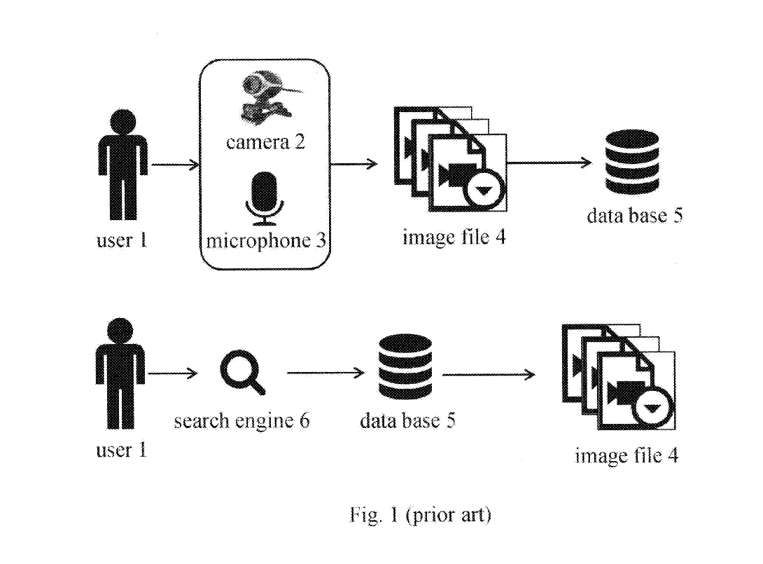

FIG. 2 shows schematically a method of searching for multimedia image according to the present invention by setting up a text file for each multimedia image.

FIG. 3 shows schematically that camera and microphone in the method of searching for multimedia image according to the present invention are not in a same device.

FIG. 4 shows schematically a flow chart for setting up a text file in the method of searching for multimedia image according to the present invention.

FIG. 5 shows schematically how to search the image file in the method of searching for multimedia image according to the present invention.

FIG. 6 shows schematically a flow chart of the search algorithm in the method of searching for multimedia image according to the present invention.

### DETAILED DESCRIPTIONS OF THE PREFERRED EMBODIMENTS

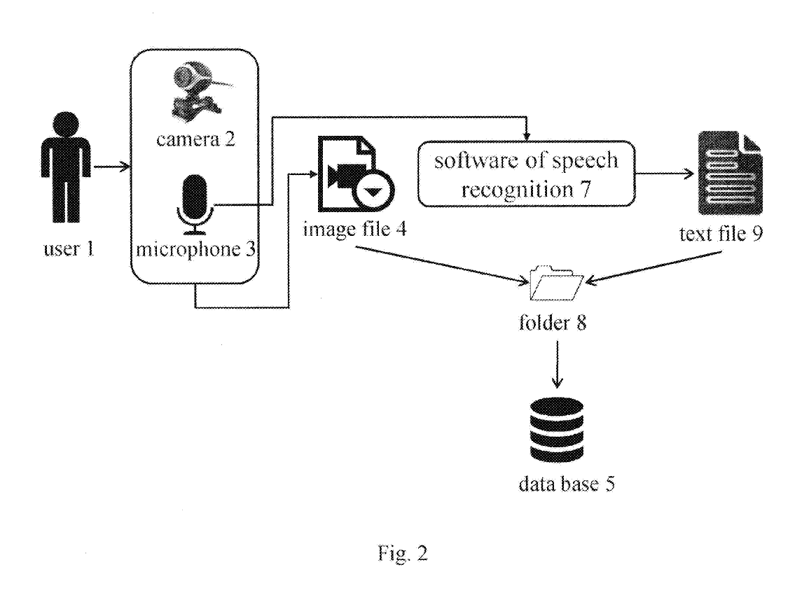

Referring to FIG. 2, which shows schematically a method of searching for multimedia image according to the present invention by setting up a text file for each multimedia image. A user 1 uses a camera 2 and a microphone 3 for recording an image file 10. A software of speech recognition 7 (such as Google speech recognition, Apple Siri speech recognition, YouTube speech recognition) is used for converting the speech recorded by the microphone 3 into a text file 9, and then the image file 10 and the text file 9 are combined to form a folder 8 for storing into a data base 5. The camera 2 and the microphone 3 can be located in a same device (such as a smart phone) or can be independent with each other.

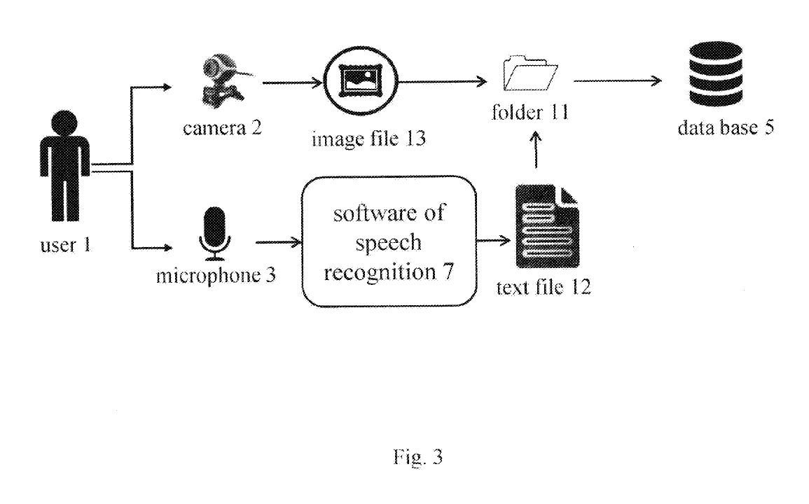

Referring to FIG. 3, the camera 2 and the microphone 3 are not in a same device. The user 1 uses the camera 2 for recording the image file 13, and also uses the microphone 3 for recording speech inputted specifically by the user 1. The speech is converted into a text file 12 by a software of speech recognition 7, then the image file 13 and the text file 12 are combined to form a folder 11 for storing into the data base 5.

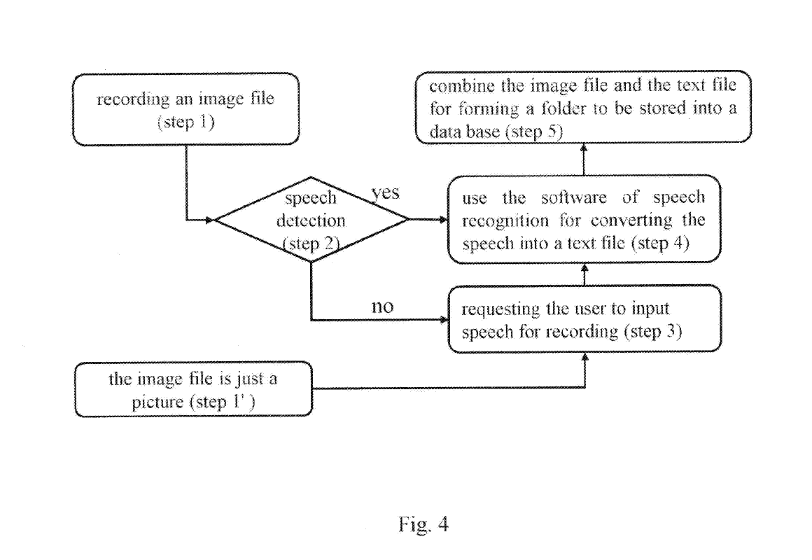

Referring to FIG. 4, which is a flow chart for setting up a text file in the method of searching for multimedia image according to the present invention. In step 1, a user 1 uses the camera 2 and the microphone 3 for recording an image file. In step 2, conducting speech detection, if there is speech, then enter step 4 to use the software of speech recognition for converting the speech into a text file, thereafter enter step 5 to combine the image file and the text file for forming a folder to be stored into a data base. If there is no speech in step 2, then enter step 3, requesting the user to input speech for recording, enter step 4 to use the software of speech recognition for converting the speech into a text file, thereafter enter step 5 to combine the image file and the text file for forming a folder to be stored into a data base. If the image file is just a picture, as shown in step 1′, then enter step 3, requesting the user to input speech for recording, enter step 4 to use the software of speech recognition for converting the speech into a text file, thereafter enter step 5 to combine the image file and the text file for forming a folder to be stored into a data base.

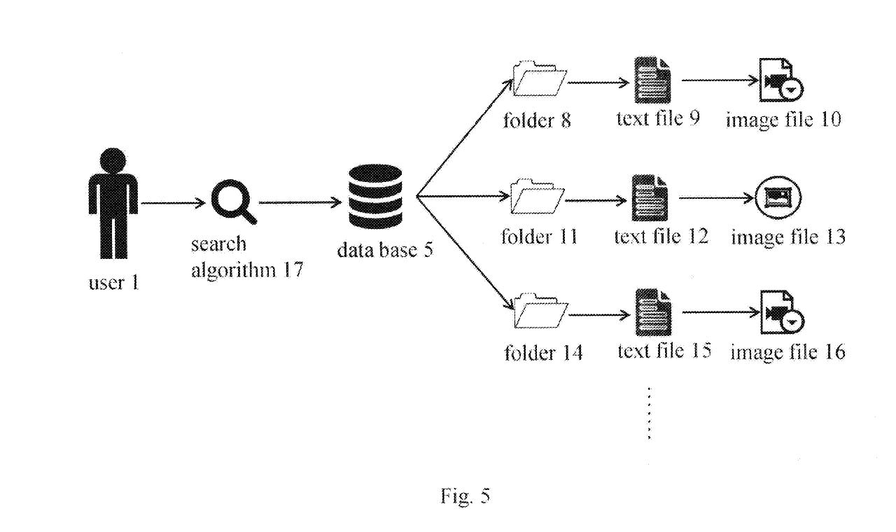

Referring to FIG. 5, which shows schematically how to search the image file in the method of searching for multimedia image according to the present invention. The user 1 uses a search algorithm 17 to search all folders 8, 11, 14 in the data base 5. The search method is to use a key word to search in the text files 9, 12, 15, therefore it is very easy to find the required image files in the image files 10, 13, 16.

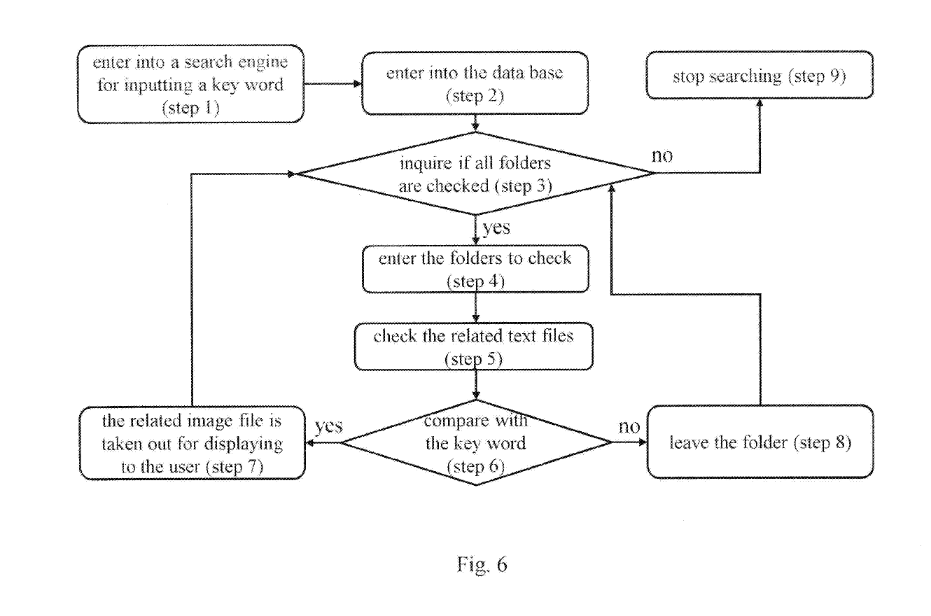

Referring to FIG. 6, which is a flow chart of the search algorithm 17 in the method of searching for multimedia image according to the present invention. In step 1, enter into a search engine for inputting a key word. In step 2, enter into the data base. In step 3, inquire if all folders are checked, if not, then enter the folders to check (step 4), and check the related text files (step 5), compare with the key word to see if it is matched with the key word (step 6), if yes, then the related image file is taken out for displaying to the user (step 7), return to step 3 for checking other folders; if no match, then leave the folder (step 8), return to step 3 for checking other folders. In step 3, if all folders are checked, then enter step 9 to stop searching.

The scope of the present invention depends upon the following claims, and is not limited by the above embodiments.

What is claimed is:

1. A method of searching for multimedia image, comprising steps as below:
a. a user uses a camera and a microphone for recording an image file, a software of speech recognition is then used for converting a speech recorded by the microphone into a text file, and then the image file and the text file are combined to form a folder to be stored in a data base;
b. if the user wants to search for a certain image file from the data base, a search engine is entered for inputting a key word;
c. enter into the data base to inquire if all folders are checked;
d. if the folders are not all checked, then enter a folder to check the related text file, compare with the key word to see if it is matched with the key word, if yes, then the related image file is taken out for displaying to the user, return to step c for checking other folders, if no match, then leave the folder, return to step c for checking other folders;
e. in step c, if all folders are checked, then stop searching.

2. The method of searching for multimedia image according to claim 1, wherein the camera and the microphone are not in a same device, the user uses the camera for recording the image file; and also uses the microphone for recording speech inputted specifically by the user; the speech is converted into a text file by the software of speech recognition, then the image file and the text file are combined to form the folder for storing into the data base.

3. The method of searching for multimedia image according to claim 1, wherein the camera and the microphone are in a smart phone.
